(19) United States
(12) Patent Application Publication
(10) Pub. No.: US 2010/0058257 A1
(43) Pub. Date: Mar. 4, 2010

(54) TOPOLOGY OPTIMIZATION METHOD USING EQUIVALENT STATIC LOADS

(75) Inventor: Gyung Jin Park, Gyeonggi-do (KR)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: IUCF-HYU (Industry-University Cooperation Foundation Hanyang University), Seoul (KR)

(21) Appl. No.: 12/271,608

(22) Filed: Nov. 14, 2008

(30) Foreign Application Priority Data
Aug. 29, 2008 (KR) 10-2008-0085015

(51) Int. Cl. G06F 17/50

(52) U.S. Cl. 716/2; 716/5

(57) ABSTRACT

A topology optimization method. Characteristics of a structure to be designed are differentiated to calculate equivalent static loads. A relative fraction of material is adopted as a design variable. It is determined whether or not an element exists based on an objective function and constraints. Design topology is derived through a linear static analysis that processes the equivalent static loads as multiple loading conditions. Topology of the structure to be designed is compared with the design topology, and thereby the progress of optimization is determined. The topology optimization processes are terminated when a difference of the compared result is less than a setup value, and are returned to an initial step when the difference is greater than the setup value, and the equivalent static loads are calculated using the design topology as a new structure to be designed.

### BACKGROUND OF THE INVENTION

1. Field of the Invention

The present invention relates, in general, to optimization of a structure and, more particularly, to topology optimization of a structure.

2. Description of the Related Art

The optimization of a structure can be defined as a design technique based on a mathematical method of determining design variables meeting simultaneously minimization of an objective function and all design constraints when all design parameters and loading conditions are given.

Here, the design variables refer to variables for design set beforehand, for instance a structural shape, arrangement, structural material, etc. determined at the basic planning step. The loading conditions refer to all types of loads that must be considered in the design. The objective function is to formulate standards complying with the purpose of the design of a structure, for instance, standards of weight, performance, etc. Further, the design constraints include restrictions of the specification, design criteria, etc., limitations in light of production, and so on.

Structural optimization can be divided into the three types of size, shape and topology according to a design variable to be finally obtained. FIG. 2 illustrates the concepts of size, shape and topology optimization.

The size optimization means designing dimensions, namely a thickness, a cross section, etc., required of a structure. The configuration of the structure itself is maintained in an optimization process without a change.

The shape optimization means determining an optimal solution using the shape of a structure as a variable. In comparison with the size optimization, the shape optimization differs in that the configuration of the structure is varied, but belongs to a conceptually similar domain, and thus makes use of a similar method for analysis.

The topology optimization means determining distribution of material, particularly the determination of from which portion the material should be removed under a given environment and which portion should be reinforced with the material in a given environment. The term “topology” originates from topographic mathematics or topographic geometry. Conceptually, there is a clear difference between the topology optimization and the size optimization and between the topology optimization and the shape optimization.

The size optimization does not change the configuration of the structure. The shape optimization changes shape, but cannot obtain design results of, for instance, making a new hole in a design target or eliminating an existent hole. In contrast, the topology optimization provides the different design results similar to either of making a nonexistent hole or filling an existent hole with the material.

These differences will be described below on the basis of a finite element method used for analysis of the structural optimization.

The finite element method is used in one of structural mechanics using a matrix, and is a method that sets up equations for individual finite elements without solving problems on an entire structure at a time, combines the equations, and obtains equations for the entire structure. For structural optimization, an optimal solution is generally obtained by breaking a design domain into discrete finite elements, and analyzing information made up of elements and nodes using the finite element method.

Size optimization is a design method in which only thicknesses of the elements are varied without a change in information about elements or nodes of a finite element model. Shape optimization is a design method in which information about nodes, i.e. coordinate values, of the finite element model are varied.

In this manner, size optimization and shape optimization use the information about the nodes and the elements of the finite element model, while topology optimization uses each element of the finite element model as a design variable. This is because topology optimization is a method of determining whether or not the material constituting the element exists.

Consequently, the number of elements is the number of design variables occurring in the topology optimization. However, in view of characteristics of the optimization that determine a direction in which the design is to be advanced by calculating the objective function of the design variables and variation of the constraints, as the number of design variables increases, problems with time and efficiency occur. Thus, the methods applied to conventional size and shape optimization cannot be applied to topology optimization.

As a large quantity of calculations has been made possible due to development of computer technologies, size and shape optimization methods have also greatly developed, but topology optimization has not yet seen the benefits due to problems of high costs and time. However, when topology optimization is performed prior to size and shape optimization, design costs can be greatly reduced, and very excellent results can be obtained in the case in which reduction in weight is an important design element. For this reason, an increasing interest is taken in topology optimization.

### SUMMARY OF THE INVENTION

Accordingly, embodiments of the present invention provide a topology optimization method, capable of being applied to topology optimization of various systems, being designed using a small number of analyses, and obtaining a very accurate solution in consideration of many design variables.

In an exemplary embodiment of the present invention, there is provided a topology optimization method, which includes: a first step of classifying characteristics of a structure to be designed and calculating equivalent static loads consistent with the characteristics; a second step of deriving design topology through linear static analysis in which the equivalent static loads are processed under multiple loading conditions, wherein a design variable is a relative fraction of material which determines the existence of the material of an element, and the existence of each element is determined according to an objective function and constraints; and a third step of comparing topology of the structure to be designed with the design topology and determining whether to progress or not.

The topology optimization processes may be terminated when a difference of the compared result in the third step is less than a setup value, and return to the first step to calculate the equivalent static loads using the design topology as a new structure to be designed when a difference of the compared result in the third step is greater than a setup value.

In another embodiment of the present invention, in the second step, the objective function may be strain energy, and the constraints may be distribution of the material.

In another embodiment of the present invention, the strain energy may be a function of density and Young's modulus of the material, and the density and Young's modulus of the material may be a function of the design variable.

In another embodiment of the present invention, the third step may include the sub-steps of: comparing the topology of the structure to be designed with the design topology respectively on a basis of each element; calculating a percentage of the elements having the difference of the compared result greater than the setup value; and comparing the calculated percentage with a setup percentage and determining whether to progress or not, wherein, in the sub-step of determining whether to progress or not, the topology optimization processes are terminated when the calculated percentage is less than a setup percentage, and are returned to the first step to calculate the equivalent static loads using the design topology as a new structure to be designed when the calculated percentage is greater than a setup percentage.

In another embodiment of the present invention, in the first step, the equivalent static loads may be calculated by multiplying displacements in all steps of time and a linear stiffness matrix, when the characteristics of the structure is a linear dynamic system, the displacements being calculated by means of an equation of motion of a linear system considering dynamic effects such as an inertia effect and a vibration effect caused by mass.

In another embodiment of the present invention, in the first step, the equivalent static loads may be calculated by multiplying nonlinear nodal displacements calculated using an equilibrium equation of a nonlinear system and a linear stiffness matrix, when the characteristics of the structure is a nonlinear static system.

In another embodiment of the present invention, in the first step, the equivalent static loads may be calculated by multiplying nonlinear displacements in all steps of time and a linear stiffness matrix, when the characteristics of the structure include a nonlinear dynamic system, the nonlinear displacements being calculated by means of an equation of motion of a nonlinear dynamic system considering dynamic effects such as an inertia effect and a vibration effect caused by mass.

According to embodiments of the present invention, the equivalent static loads calculated by reflecting environmental features of various systems are used. Thereby, topology optimization can be performed using an analysis method of a linear static system. Thus, topology optimization can be applied to almost all systems. Further, topology optimization remarkably reduces a number of times analysis is performed and considers many design variables, thereby obtaining an accurate solution.

In addition, information errors of finite elements accompanied with the topology optimization of a nonlinear system can be completely prevented.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

It is to be understood that both the foregoing general description and the following detailed description of the present invention are exemplary and explanatory, and are intended to provide further explanation of the invention as claimed.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is a flow chart illustrating a topology optimization method using equivalent static loads according to an embodiment of the present invention; and

FIG. 2 illustrates the concepts of size, shape and topology optimization.

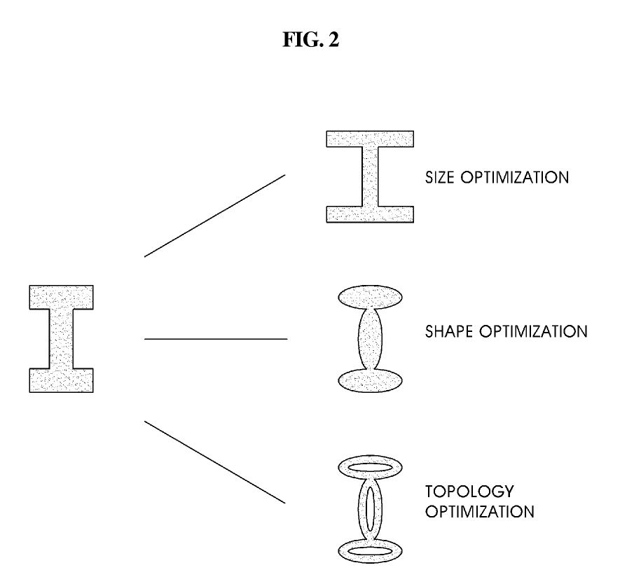

### DETAILED DESCRIPTION OF THE INVENTION

Reference will now be made in greater detail to exemplary embodiments of the invention with reference to the accompanying drawings.

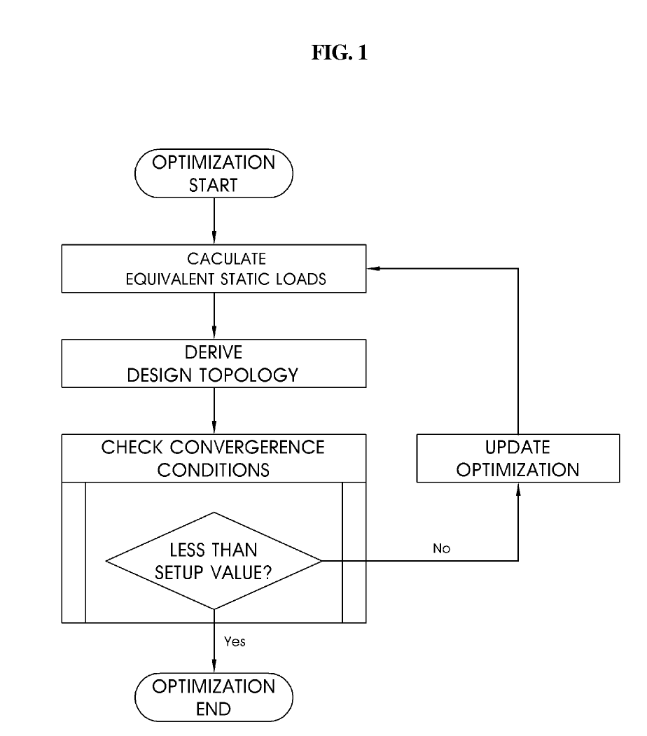

FIG. 1 is a flow chart illustrating a topology optimization method using equivalent static loads according to an embodiment of the present invention.

First, equivalent static loads are calculated on the basis of characteristics of a structure to be designed (step 1).

The equivalent static load refers to a load in a static linear system that generates a response identical to that represented in a dynamic system. A paper of “numerical optimization of a dynamic system using equivalent static loads” has been initially issued in 2000 by the inventors of the present invention. Afterwards, numerical and shape optimization using equivalent static loads in various systems have been issued through famous academic journals at home and abroad. However, no research has been issued in connection with topology optimization using equivalent static loads. A method of obtaining equivalent static loads in a system having various characteristics is equal to that of the paper issued by the inventors of the present invention, and so its description will be described below.

A design topology is derived using the equivalent static loads as multiple loading conditions (step 2).

All problems of optimization can be expressed to find design variables of an objective function having a minimum value in consideration of constraints in a given design domain. This optimization uses sensitivity analysis in the process of finding a design value. The purpose of the sensitivity analysis is to evaluate influences of the objective function and constraints depending on a change in design variables. Thus, as the number of design variables increases, the amount of the sensitivity analysis increases. As such, it is very difficult to perform topology optimization having a large number of design variables by using sensitivity analysis.

The inventors of the present invention have found that, when performed by an equivalent load method using the equivalent static loads, topology optimization can be applied to almost all systems, a very correct solution can be obtained, and the number of times required for performance of an analysis may be greatly reduced.

A numerical formula deriving design topology using the equivalent static loads is as follows.

Find x

to minimize S(ρ(x), E(x))

subject to Kₜₒ^{L}(ρ(x), E(x))z^{L}=f_{eq}

m(ρ(x), E(x))≦m_{reference}×α

ρ=ρ(x)

E=E(x)

0.0≦x≦1.0

In the formula above, x is the design variable for topology optimization, and refers to a relative fraction of material which determines whether or not the material of an element exists. If x approaches 0 (zero), the material of the element does not exist. If x approaches 1 (one), the material of the element exists. At this time, density ρ and Young's modulus E of the material are a function of the design variable x. S is the strain energy, and is the objective function for the topology optimization. The strain energy is the function of the function of ρ and E, i.e. the design variable x. f_{eq} is a equivalent static loads, and is calculated by multiplying a stiffness matrix Kₜₒ^{L}(ρ(x),E(x)) as the function of the density and the Young's modulus and a linear displacement vector Z^{L}(t). The constraints of the topology optimization are mass fraction, namely an amount of material determined to be left in the design domain m_{reference}. For example, if the topology optimization is to be performed within a range where the material is left in the design domain only by 50%, α is defined as 0.5. The design topology that minimizes the strain energy within a range where a desired amount of material is left in the design domain is derived.

The use of the equivalent static loads makes it possible to derive the design topology with respect to all the systems through linear static analysis. These equivalent static loads are processed on multiple loading conditions in the linear static analysis process, and act as an external force. In other words, all the equivalent static loads can be simultaneously applied, and an optimal solution takes consideration of a response in all steps of time. For example, in the case of the design considering dynamic characteristics, the related art has performed the optimization using dynamic coefficients or only partial responses to the most dangerous time zone. This conventional method has a high possibility of obtaining an unexpected result when a dangerous time is changed while the design is performed. In contrast, the equivalent static load method has no such a drawback because the responses to all times are considered.

It is checked whether or not the derived design topology meets convergence conditions (step 3).

When the analysis is preformed using an initial design value changed from the derived design topology, an effect on design improvement is obtained, but there occurs the case in which the constraints which a designer wants in the initial stage are not met. This is attributable to a difference between sensitivity of a dynamic, nonlinear static, or nonlinear dynamic analysis and sensitivity of a static analysis. In order to overcome this sensitivity difference, the overall processes must be performed again. The sensitivity difference is gradually reduced by this repetition. Finally, all responses and sensitivities are nearly matched with each other, and thus the optimal solution that meets the original constraints of the designer is obtained. Accordingly, it should be checked whether or not the derived design topology meets the convergence conditions. Here, the convergence conditions refer to conditions in which the design value is no longer changed although the design is advanced. When the convergence conditions are met, the design value is determined as the optimal solution of the topology optimization, and then the analysis is terminated. In contrast, when the convergence conditions are not met, the optimization is performed from step 1 again using the design topology value as an initial value.

A numerical formula expressing the convergence conditions is as follows.

∥xᵢ^{(k)}−xᵢ^{(k-1)}∥≦ε₁; i=1, . . . , n

In this formula, xᵢ refers to the i-th design variable, and k refers to the design step. When a difference between design results is less than a predetermined value ε₁ (hereinafter, referred to as “setup value”), it is regarded to be converged.

However, since the topology optimization sets all elements of the structure as the design variables, it is difficult for all design variables to satisfy the formula. Thus, when the number of all design variables is n, the number of elements violating the formula is counted. If the counted number does not exceed a preset percentage of all design variables, it is regarded to be converged. A numerical formula expressing this relation is as follows.

countif(∥xᵢ^{(k)}−xᵢ^{(k-1)}∥≧ε₁)≧n×ε₂

In this formula, ε₂ is the arbitrarily determined percentage (hereinafter, referred to as “setup percentage”).

For example, in the case of the structure having 1000 elements, the number n of all design variables is 1000. Assuming that the setup percentage ε₂ be 1%, when the number of elements, in which a difference between the design variables of a current design step and those of a previous design step is greater than the setup value ε₁, is less than 10 corresponding to 1% of the number n, this meets the convergence conditions.

If the convergence conditions are not met, the optimization must be performed from step 1 again using the design topology value as the initial value. However, since the result value of the design variable x of the topology optimization is expressed by the relative percentage value of the material distribution of the structure, it is impossible to directly apply the result value as an initial value of the next optimization step. As such, a process of updating the optimization using the design result value x must be performed. For example, although all the elements of the structure begin with the material having the same values of physical properties in the initial stage, the individual elements of the structure have different design result values when the topology optimization is completed once. At this time, the design results are calculated by the relative percentage of the material distribution of the elements, the values of physical properties such as Young's modulus, density etc. must be calculated using the calculated percentage. In other words, in order to update the optimization from the results of the topology optimization, the values of physical properties of the material must be changed.

A numerical formula, which calculates the values of physical properties of the material to be used in an analysis step of the next optimization step, i.e. the (k+1)-th optimization step using the design variable xᵢ^{(k)} obtained from the results of the topology optimization on the basis of the Young's modulus and the density when the design is initiated in the k-th optimization step, is as follows.

Eᵢ^{(k+1)}=Eᵢ^{(k)}×(xᵢ^{(k)})³

ρᵢ^{(k+1)}=ρᵢ×xᵢ^{(k)}

If the material of a certain portion disappears as a result of performing topology optimization in a certain optimization step, the values of physical properties of the material of that portion are small. When the equivalent static loads are calculated in the next optimization step using these corrected values of physical properties of the material, the equivalent static loads are calculated to have a small value at the material-free portion. As the optimization step proceeds, the portion where the material is distributed is sharply discriminated from the portion where the material disappears. This means approaching termination of the optimization processes.

Further, in the case of conventional topology optimization considering nonlinear static and dynamic characteristics, an error is generated from the information about the finite elements. In detail, when the topology optimization proceeds, the element from which the material disappears is generated. For this reason, when the nonlinear analysis is performed, the information about the material-free element interferes with that about the neighboring elements. This phenomenon is a troublesome problem with topology optimization considering nonlinearity. However, according to an embodiment of the present invention, since the equivalent static loads of the material-free element are applied as small values in the process of updating the optimization, the information error of the infinite elements can be prevented.

As described up to now, a series of optimization processes that are performed by calculating the equivalent static loads complying with the system and applying the calculated results to the topology optimization as multiple loading conditions makes no difference regardless of the environment which governs the system. However, the process of performing the analysis suitable for the environment which the system is in, to obtain the equivalent static loads, makes a difference. Now, a method of calculating the equivalent static loads suitable for individual characteristics will be described in brief.

In the linear dynamic system, the equivalent static loads are calculated by multiplying the linear stiffness matrix of the finite element model and a displacement field obtained from dynamic analysis results. Thus, in order to calculate the equivalent static loads, linear dynamic analysis is performed.

An equation of motion of the structure for the dynamic analysis is as follows.

Mₜₒ^{L}(ρ(x), E(x))\ddot{z}^{L}(t)+Kₜₒ^{L}(ρ(x), E(x))z^{L}(t)=f(t)

In this equation, Mₜₒ^{L}(ρ(x),E(x)) and Kₜₒ^{L}(ρ(x),E(x)) are the mass matrix and the stiffness matrix of the topology, and are functions of the density vector ρ and Young's modulus vector E. At this time, the density and Young's modulus are functions of the design variable of the topology optimization. z^{L}(t) is the displacement vector based on dynamic load, and f(t) is the dynamic load for dynamic analysis. The displacement vector z^{L}(t) can be obtained from this dynamic analysis in all steps of time. Here, the superscript L means linearity.

Next, a formula for calculating the equivalent static loads is as follows.

f_{eq}(t)=Kₜₒ^{L}(ρ(x), E(x))z^{L}(t)=f(t)−Mₜₒ^{L}(ρ(x), E(x))\ddot{z}^{L}(t)

In this formula, the equivalent static load can be calculated by multiplying the dynamic displacement field z^{L}(t) and the stiffness matrix Kₜₒ^{L}(ρ(x),E(x)) at an arbitrary time. Here, the stiffness matrix Kₜₒ^{L}(ρ(x),E(x)) can be obtained from a finite element analyzer. This obtained f_{eq} is a load used for the static analysis in order to conform to a displacement field at all temporal nodes. If the dynamic analysis is performed by dividing a time t into n steps of time, the equivalent static load has a set of loads of the total number n.

Finally, a finite element equation for the static analysis is as follows.

Kₜₒ^{L}(ρ(x), E(x))z^{L}(s)=f_{eq}(s)

In this equation, f_{eq}(s) is the equivalent static load acting as an external force, and z^{L}(s) is the linear displacement vector calculated from this analysis. This linear displacement vector is accurately matched with the dynamic displacement vector z^{L}(t) at all temporal nodes. Thus, it can be seen that the use of the equivalent static load allows the dynamic displacement field to be obtained through static analysis. The equivalent static load f_{eq} is applied to topology optimization considering the dynamic characteristics. The equivalent static load applied when the dynamic load acts in this way, and is applied as a loading condition in the topology optimization.

In the design of the nonlinear static system, the load ought to be called equivalent load rather than the equivalent static load because no consideration of the dynamic characteristic, i.e. the time, is taken. However, the load is expressed the equivalent static load in order to be identical to the term in the dynamic system. The equivalent static load in the nonlinear static system is calculated by multiplying the stiffness of the infinite element model and the displacement field obtained from the nonlinear static analysis. First, the nonlinear analysis is performed.

An equilibrium equation of the nonlinear static system is as follows.

Kₜₒ^{N}(ρ(x), E(x), z^{N})z^{N}=f

In this equation, Z^{N} is the nonlinear displacement vector, and it can be calculated from nonlinear static analysis using the equilibrium equation. Here, the superscript N refers to the value obtained from the nonlinear analysis, and the superscript L refers to the value obtained from the linear analysis. As can be seen from the equilibrium equation, in the case of the linear analysis, the stiffness matrix Kₜₒ^{L}(ρ(x),E(x)) is only the function of the density ρ and Young's modulus E, which are the function of the design variable x. However, the nonlinear stiffness matrix Kₜₒ^{N}(ρ(x),E(x),z^{N}) is this function as well as the function of the nonlinear displacement vector Z^{N}.

Next, a formula for calculating the equivalent static load is as follows.

f_{eq}=Kₜₒ^{L}(ρ(x), E(x))z^{N}

The equivalent static load f_{eq} can be obtained by multiplying the nonlinear nodal displacement vector obtained from the nonlinear analysis by the linear stiffness matrix Kₜₒ^{L}(ρ(x),E(x)).

Finally, when the linear analysis is performed again using f_{eq} calculated from the following formula, a linear nodal displacement vector Z^{L} can be obtained.

Kₜₒ^{L}(ρ(x), E(x))z^{L}=f_{eq}

The linear nodal displacement vector Z^{L} obtained at this time is equal to the nonlinear displacement vector Z^{N} obtained from the equilibrium equation. In other words, f_{eq} refers to the equivalent static load causing a displacement field equal to that derived from the nonlinear analysis. The nonlinear analysis calculates a final displacement field using a method of increasing a unit load to calculate displacement. The conformity of the displacement field using the equivalent static load method has clear relation as described above. In other words, only a final displacement value is required regardless of the process in which the displacement is calculated in the nonlinear analysis. The topology optimization is performed using this calculated equivalent static load.

In the nonlinear dynamic system, the equivalent static load can be calculated by multiplying the linear stiffness matrix of the finite element model and the response obtained from the nonlinear dynamic analysis. Thus, in order to calculate the equivalent static load, the nonlinear dynamic analysis must be performed in advance.

A finite element equation for the nonlinear dynamic analysis is as follows.

Mₜₒ^{N}(ρ(x), E(x), z^{N}(t))\ddot{z}^{N}(t)+Kₜₒ^{N}(ρ(x), E(x), z^{N}(t))z^{N}(t)=f(t)

In this equation, Mₜₒ^{N}(ρ(x),E(x),z^{N}(t)) and Kₜₒ^{N}(ρ(x),E(x),z^{N}(t)) are the mass matrix and the nonlinear stiffness matrix, and are made up of the density ρ and Young's modulus E that are the function of the design variable x in the topology optimization, and the nonlinear displacement vector z^{N}(t) depending on a time. The nonlinear displacement vector z^{N}(t) can be obtained from the nonlinear dynamic analysis in all steps of time.

Subsequently, a formula for obtaining the equivalent static load is as follows.

f_{eq}(t)=Kₜₒ^{L}(ρ(x), E(x))z^{N}(t)

In this formula, Kₜₒ^{L}(ρ(x),E(x)) is the linear stiffness matrix, which can be easily obtained from almost all finite element analyzers. The nonlinear displacement vector z^{N}(t) obtained in advance is multiplied by the linear stiffness matrix. The equivalent static load f_{eq}(t) is obtained by this mathematical calculation. In other words, f_{eq}(t) is a load for the linear static analysis in order to accurately conform to the displacement field in all steps of time t.

Finally, an equation for the linear static finite element analysis is as follows. Hereinafter, t indicating a time will be replaced and expressed by s.

Kₜₒ^{L}(ρ(x), E(x))z^{L}(s)=f_{eq}(s)

The equivalent static load f_{eq}(s) obtained in advance acts as an external force, and is located in the right-hand term, and z^{L}(s) is the linear displacement vector calculated from this analysis. This linear displacement vector z^{L}(s) accurately conforms to the nonlinear dynamic displacement vector z^{N}(t) at all temporal nodes. Thus, it can be seen that the use of the equivalent static load allows the nonlinear dynamic displacement field to be obtained through the linear analysis. This obtained equivalent static load can be applied to topology optimization considering the nonlinear dynamic characteristics under the multiple loading conditions.

Although an exemplary embodiment of the present invention has been described for illustrative purposes, those skilled in the art will appreciate that various modifications, additions and substitutions are possible, without departing from the scope and spirit of the invention as disclosed in the accompanying claims.

1. A topology optimization method comprising:
a first step of classifying characteristics of a structure to be designed and calculating equivalent static loads consistent with the characteristics;
a second step of deriving design topology through linear static analysis in which the equivalent static loads are processed under multiple loading conditions, wherein a design variable is a relative fraction of material which determines the existence of the material of an element, and the existence of each element is determined according to an objective function and constraints; and
a third step of comparing topology of the structure to be designed with the design topology and determining whether to progress or not,
wherein the topology optimization method is terminated when a difference of the compared result in the third step is less than a setup value, and is returned to the first step to calculate the equivalent static loads using the design topology as a new structure to be designed when a difference of the compared result in the third step is greater than the setup value.

2. The topology optimization method as set forth in claim 1, wherein, in the second step, the objective function is strain energy, and the constraints comprise distribution of the material.

3. The topology optimization method as set forth in claim 2, wherein the strain energy is a function of density and Young's modulus of the material.

4. The topology optimization method as set forth in claim 3, wherein the density and Young's modulus of the material is a function of the design variable.

5. The topology optimization method as set forth in claim 1, wherein the third step includes the sub-steps of:
comparing the topology of the structure to be designed with the design topology respectively on a basis of each element;
calculating a percentage of the elements having the difference of the compared result greater than the setup value; and
comparing the calculated percentage with a setup percentage and determining whether to progress or not,
wherein, in the sub-step of determining whether to progress or not, the topology optimization method is terminated when the calculated percentage is less than the setup percentage, and is returned to the first step to calculate the equivalent static loads using the design topology as a new structure to be designed when the calculated percentage is greater than the setup percentage.

6. The topology optimization method as set forth in claim 1, wherein, in the first step, the equivalent static loads are calculated by multiplying displacements in all steps of time and a linear stiffness matrix, when the characteristics of the structure include a linear dynamic system, the displacements being calculated by means of an equation of motion of a linear system considering dynamic effects.

7. The topology optimization method as set forth in claim 1, wherein, in the first step, the equivalent static loads are calculated by multiplying nonlinear nodal displacements calculated using an equilibrium equation of a nonlinear system and a linear stiffness matrix, when the characteristics of the structure include a nonlinear static system.

8. The topology optimization method as set forth in claim 1, wherein, in the first step, the equivalent static loads are calculated by multiplying nonlinear displacements in all steps of time and a linear stiffness matrix, when the characteristics of the structure include a nonlinear dynamic system, the nonlinear displacements being calculated by means of an equation of motion of a nonlinear dynamic system considering dynamic effects.
